(19) United States
(12) Patent Application Publication
(10) Pub. No.: US 2013/0157045 A1
(43) Pub. Date: Jun. 20, 2013

(54) ANTI-FINGERPRINT AGENT, SURFACE TREATMENT METHOD USING THE ANTI-FINGERPRINT AGENT AND ARTICLE MANUFACTURED BY THE SAME

(71) Applicant: XU LIU, Shenzhen City (CN)

(72) Inventor: XU LIU, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/483,258

(22) Filed: May 30, 2012

(30) Foreign Application Priority Data
Dec. 17, 2011 (CN) 201110424466.0

(51) Int. Cl. C09D 5/00; B05D 1/18; B05D 3/02; B32B 15/08

(52) U.S. Cl. 428/336; 106/2; 428/421; 427/435; 427/388.4; 427/385.5; 427/430.1

(57) ABSTRACT

Anti-fingerprint agent substantially comprises liquid polytetrafluroethylene and silane solution. The volume ratio of the liquid polytetrafluroethylene to silane solution is about 0.5:1 to about 0.8:1. The silane solution substantially comprises methyl triethoxysilane, ethyl silicate, absolute ethanol, deionized water, and sulfuric acid. The surface treatment method using the anti-fingerprint agent and the article manufactured by the method is also provided.

### BACKGROUND

1. Technical Field

The present disclosure relates to an anti-fingerprint agent, a surface treatment method using the anti-fingerprint agent and articles manufactured by the surface treatment method.

2. Description of Related Art

Polytetrafluroethylene (PTFE) layers are usually formed on metal substrates by vacuum sputtering to enhance the water- and oil-repelling properties of the metal substrates. However, the PTFE layer cannot securely bond to the metal substrate. Furthermore, the PTFE layer is not transparent enough, which affects the appearance of the metal substrate. Additionally, the PTFE layer is difficult to deposit at low temperatures.

Therefore, there is room for improvement within the art.

### DETAILED DESCRIPTION

According to an exemplary embodiment, an anti-fingerprint agent substantially includes liquid PTFE and silane solution, wherein the volume ratio of liquid PTFE to silane solution is about 0.5:1 to about 0.8:1.

The silane solution substantially includes methyl triethoxyl silane, ethyl silicate, absolute ethanol, deionized water and sulfuric acid solution, wherein the volume percentage of methyl triethoxyl silane is about 60% to about 63%, the volume percentage of ethyl silicate is about 2% to about 3%, the volume percentage of absolute ethanol is about 2% to about 3% , the volume percentage of deionized water is about 25% to about 27%, the volume percentage of sulfuric acid solution is about 4% to about 11%. The sulfuric acid solution added to the silane solution is 45% by mass.

A surface treatment method using the anti-fingerprint agent includes the following steps.

A substrate is provided. The substrate may be a metal substrate, a metal substrate coated with metal compound layer or metal layer, or a non-metal substrate coated with metal compound layer or metal layer. The non-metal substrate may be a ceramic or plastic substrate. The metal compound may be a compound formed from at least one metal element and at least one non-metal element, wherein the metal element is selected from a group consisting of Al, Ti, Cr, Mg, Zr and Ni, and the non-metal element is selected from a group consisting of O, C, N and P. The metal compound layer may be formed by vacuum deposition or chemical vapor deposition. The metal layer may be made of one or more metal elements selected from a group consisting of Al, Ti, Cr, Mg, Zr and Ni. The metal layer may be formed by vacuum deposition or electroplating.

The anti-fingerprint agent is provided. The anti-fingerprint agent substantially includes liquid PTFE and silane solution, wherein the volume ratio of the liquid PTEF to silane solution is about 0.5:1 to about 0.8:1.

The anti-fingerprint agent is made by the following steps:

A silane solution is provided. The silane solution substantially includes methyl triethoxyl silane, ethyl silicate, absolute ethanol, deionized water and sulfuric acid solution, wherein the volume percentage of methyl triethoxyl silane is about 60% to about 63%, the volume percentage of ethyl silicate is about 2% to about 3%, the volume percentage of absolute ethanol is about 2% to about 3% , the volume percentage of deionized water is about 25% to about 27%, the volume percentage of sulfuric acid solution is about 4% to about 11%. The sulfuric acid solution added in the silane solution is 45% by mass.

The silane solution and the liquid PTEF are mixed and stirred to produce a mixture. The mixture is left standing for about 30 min to about 40 min. Then, the mixture is filtered to remove impurities to produce the anti-fingerprint agent.

An anti-fingerprint coating is formed on the substrate by a dipping process. The dipping process may be carried out by immersing the substrate in the anti-fingerprint agent for about 20 seconds (s) to about 30 s. Then, the substrate is baked in an oven at an oven temperature of about 150° C. to about 200° C. The anti-fingerprint coating has a thickness of about 5 μm to about 10 μm.

An article manufactured by the method includes a substrate, and an anti-fingerprint coating formed on the substrate.

The article can be a housing of a mobile phone, a personal digital assistant (PDA), a notebook computer, a portable music player, a GPS navigator, a digital camera or the like.

The substrate may be a metal substrate, a metal substrate coated with metal compound layer or metal layer, or a non-metal substrate coated with metal compound layer or metal layer. The non-metal substrate may be a ceramic or plastic substrate. The metal compound may be a compound formed from at least one metal element and at least one non-metal element, wherein the metal element is selected from a group consisting of Al, Ti, Cr, Mg, Zr and Ni, the non-metal element is selected from a group consisting of O, C, N and P. The metal compound layer may be formed by vacuum deposition or chemical vapor deposition. The metal layer may be made of one or more metal elements selected from a group consisting of Al, Ti, Cr, Mg, Zr and Ni. The metal layer may be formed by vacuum deposition or electroplating.

The anti-fingerprint coating has a thickness of about 5 μm to about 10 μm. The anti-fingerprint coating is transparent.

The anti-fingerprint coating can securely bond to the substrate. The article coated with the anti-fingerprint coating has excellent hydrophobicity, resistance to chemicals, solvent resistance, and wear resistance. The anti-fingerprint coating is transparent, which does not affect the metal appearance of the article. Additionally, the anti-fingerprint agent is simple and easy to manufacture.

The surface treatment method using the anti-fingerprint agent is simply implemented, and is environmental friendly.

### Example 1

A substrate was provided. The substrate is a plastic substrate. A Cr—C layer and a Ti—N layer were formed on the substrate in that order. The Cr—C layer and a Ti—N layer were formed by vacuum sputtering.

Manufacturing an anti-fingerprint agent: a silane solution was provided, the silane solution substantially included methyl triethoxyl silane, ethyl silicate, absolute ethanol, deionized water and sulfuric acid solution, wherein the volume percentage of methyl triethoxyl silane was about 60%, the volume percentage of ethyl silicate was about 2%, the volume percentage of absolute ethanol was about 2%, the volume percentage of deionized water was about 25%, the volume percentage of sulfuric acid solution is about 5%. The sulfuric acid solution added in the silane solution was 45% by mass.

The silane solution and liquid PTEF were mixed and stirred to produce a mixture. The mixture was left standing for about 30 minutes. Then, the mixture was filtered to remove impurities to produce the anti-fingerprint agent. The volume ratio of the liquid PTEF to silane solution is about 0.6:1.

Forming an anti-fingerprint coating: the substrate was immersed in the anti-fingerprint agent for about 30 s, then, the substrate was baked in an oven at an oven temperature of about 150° C. for about 45 min. The anti-fingerprint coating has a thickness of about 6 μm.

### Example 2

A substrate was provided. The substrate is an aluminum alloy substrate. A Cr—C layer and a Ti—N layer were formed on the substrate in that order. The Cr—C layer and a Ti—N layer were formed by vacuum sputtering.

Manufacturing an anti-fingerprint agent: a silane solution was provided, the silane solution substantially included methyl triethoxyl silane, ethyl silicate, absolute ethanol, deionized water and sulfuric acid solution, wherein the volume percentage of methyl triethoxyl silane was about 63%, the volume percentage of ethyl silicate was about 3%, the volume percentage of absolute ethanol was about 3%, the volume percentage of deionized water was about 26.5%, the volume percentage of sulfuric acid solution is about 9%. The sulfuric acid solution added in the silane solution was 45% by mass.

The silane solution and liquid PTEF were mixed and stirred, the mixture sat still for about 40 minutes; then, the mixture was filtered to remove impurities to produce the anti-fingerprint agent. The volume ratio of liquid PTEF to silane solution is about 0.8:1.

Forming an anti-fingerprint coating: the substrate was immersed in the anti-fingerprint agent for about 30 s, then, the substrate was baked in an oven at an oven temperature of about 180° C. for about 50 minutes. The anti-fingerprint coating has a thickness of about 8 μm.

### Example 3

Unlike example 2, a Zr—N layer was deposited directly on the substrate in example 3, instead of on the Cr—C and Ti—N layer of example 2, by a vacuum sputtering process. Except for the above difference, the remaining experiment conditions of example 3 were the same as for example 2.

### Example 4

Unlike example 2, a Ni layer was formed by anodizing on the substrate in example 4, instead of the Cr—C layer and a Ti—N layer on the substrate of example 2. Except for the above difference, the remaining experiment conditions of the example 4 were the same as in example 2.

### Example 5

Unlike example 2, the bare substrate of example 5 is simply and directly coated with the anti-fingerprint coating. Except for the above difference, the remaining experiment conditions of example 5 were the same as in example 2.

### Comparison Example 1

A substrate was provided. The substrate is an aluminum alloy substrate. A Cr—C layer and a Ti—N layer were formed on the substrate in that order. The Cr—C layer and the Ti—N layer were formed by vacuum sputtering.

Forming a PTFE layer on the substrate: the substrate was immersed in a PTEF ethanol solution for about 30 s. Then, the substrate was baked in an oven at an oven temperature of about 150° C. for about 45 minutes. The volume percentage of the PTFE was about 60%. The thickness of the PTEF layer was about 10 μm.

### Comparison Example 2

A substrate was provided. The substrate is an aluminum alloy substrate. A Cr—C layer and a Ti—N layer were formed on the substrate in that order. The Cr—C layer and the Ti—N layer were formed by vacuum sputtering.

Forming a silane layer on the substrate: the substrate was immersed in a silane solution for about 30 s. Then, the substrate was baked in a oven at an oven temperature of about 180° C. for about 45 minutes. The silane solution substantially included methyl triethoxyl silane, ethyl silicate, absolute ethanol, deionized water and sulfuric acid solution, wherein the volume percentage of methyl triethoxyl silane was about 57%, the volume percentage of ethyl silicate was about 3%, the volume percentage of absolute ethanol was about 13%, the volume percentage of deionized water was about 20%, the volume percentage of sulfuric acid solution was about 7%. The sulfuric acid solution added in the silane solution was 45% by mass. The thickness of the silane layer was about 6 μm.

### RESULTS OF THE EXAMPLES

Hydrophobicity test, chemicals resistance test, solvent resistance test, and wear resistance tests were performed on the coatings of examples 1-5 and comparison examples 1-2.

The hydrophobic angles of the articles are listed in Table 1, as below.

TABLE 1

| articles | hydrophobic angle |
|---|---|
| example 1 | 150° |
| example 2 | 153° |
| example 3 | 153° |
| example 4 | 151° |
| example 5 | 150° |
| comparison example 1 | 106° |
| comparison example 2 | 68° |

Chemical resistance testing was carried out as follows. The articles were coated with chemicals and left standing for about 24 hours, then the chemicals were removed from the surface of the articles. The chemicals were selected from a group consisting of hand cream, sunscreen, lipstick, foundation cream, insecticide and edible oil. The chemicals are listed in Table 2, as below.

TABLE 2

| chemicals | brand | type |
|---|---|---|
| hand cream | Nivea whitening hydration | 84663 |
| | hand cream | |
| sunscreen | Nivea firming sun lotion | 85656 |
| lipstick | Bleunuit | 07-XK-0003 |
| foundation cream | Olay whitening track-free | OB-2 |
| | liquid foundation | |
| insecticide | Teho Hyttysgeeli | 64003740 |
| edible oil | Jinlongyu | Blending oil |

The tests showed no discoloration, no pitting corrosion, and no peeling occurring on the coatings of examples 1-5. The coatings in comparison examples 1-2 were found to have a slight pitting corrosion. That is, the coatings of examples 1-5 had better chemical resistance than that of the coatings of comparison examples 1-2.

Solvent resistance testing was carried out as follows. The articles were repeatedly wiped by a cotton piece with a force of about 6 newtons (N) to about 12 N for 200 times in 2 minutes. The cotton piece was impregnated with petroleum ether (60-90), isopropanol (having a mass percentage of about 99.7%), and artificial sweat. The coatings of examples 1-5 subjected to the test were then left standing for 2 hours. The tests showed no discoloration occurring on the coatings of examples 1-5. In contrast, a slight pitting corrosion was found on the surface of the coating of comparison example 1, and serious pitting corrosion was found on the coating of comparison example 2.

Adhesion testing was carried out using a cross-cut test according to ISO 2409 standard. The test results are listed in Table 3, as below.

TABLE 3

| articles | adhesive test result |
|---|---|
| example 1 | Grade 0 |
| example 2 | Grade 0 |
| example 3 | Grade 0 |
| example 4 | Grade 0 |
| example 5 | Grade 0 |
| comparison example 1 | Grade 2 |
| comparison example 2 | Grade 5 |

The tests above indicate very secure bonding by the anti-fingerprint coatings of examples 1-5 to the substrate.

Wear resistance testing was carried out as follows. The articles were tested by a “MCJ-01” type scratch tester (provided by Ji'nan Kai Rui Cnc Equipment Limited Company) at an initial load force of about 1 N and a scratch speed of about 10 millimeters per second until the surface of the coating was found to be scratched. During the test, the load force was increased at a rate of 1 N per second (N/S). The test results are listed in Table 4, as below.

TABLE 4

| | the load force when scratch |
|---|---|
| articles | was found on articles |
| example 1 | 15N |
| example 2 | 15N |
| example 3 | 15N |
| example 4 | 17N |
| example 5 | 16N |
| comparison example 1 | 6N |
| comparison example 2 | 20N |

The tests indicate that the coatings of examples 1-5 have high wear resistance.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being exemplary embodiments of the disclosure.

What is claimed is:

1. An anti-fingerprint agent, comprising:
liquid polytetrafluroethylene; and
silane solution, the volume ratio of the liquid polytetrafluroethylene to silane solution being about 0.5:1 to about 0.8:1, the silane solution substantially comprising methyl triethoxyl silane, ethyl silicate, absolute ethanol, deionized water, and sulfuric acid solution.

2. The anti-fingerprint agent as claimed in claim 1, wherein volume percentage of the methyl triethoxyl silane is about 60% to about 63%.

3. The anti-fingerprint agent as claimed in claim 1, wherein volume percentage of the ethyl silicate is about 2% to about 3%.

4. The anti-fingerprint agent as claimed in claim 1, wherein volume percentage of the absolute ethanol is about 2% to about 3%.

5. The anti-fingerprint agent as claimed in claim 1, wherein volume percentage of the deionized water is about 25% to about 27%.

6. The anti-fingerprint agent as claimed in claim 1, wherein volume percentage of the sulfuric acid solution is about 4% to about 11%.

7. The anti-fingerprint agent as claimed in claim 6, wherein the sulfuric acid solution added in the silane solution is 45% sulfuric acid by mass.

8. A surface treatment method using an anti-fingerprint agent comprising:
providing a substrate, the substrate being made of metal or non-metal;
providing an anti-fingerprint agent, the anti-fingerprint agent substantially comprising liquid polytetrafluroethylene and silane solution, the volume ratio of the liquid polytetrafluroethylene to silane solution being about 0.5:1 to about 0.8:1, the silane solution substantially comprising methyl triethoxyl silane, ethyl silicate, absolute ethanol, deionized water, and sulfuric acid solution;
forming an anti-fingerprint coating on the substrate by a dipping process.

9. The surface treatment method as claimed in claim 8, wherein volume percentage of the methyl triethoxyl silane is about 60% to about 63%.

10. The surface treatment method as claimed in claim 8, wherein volume percentage of the ethyl silicate is about 2% to about 3%.

11. The surface treatment method as claimed in claim 8, wherein volume percentage of the absolute ethanol is about 2% to about 3%.

12. The surface treatment as claimed in claim 8, wherein volume percentage of the deionized water is about 25% to about 27%.

13. The surface treatment method as claimed in claim 8, wherein volume percentage of the sulfuric acid solution is about 4% to about 11%.

14. The surface treatment method as claimed in claim 8, wherein the anti-fingerprint agent is manufactured by the following steps: silane solution and liquid polytetrafluroethylene are mixed and stirred to produce a mixture, the volume ratio of liquid polytetrafluroethylene to silane solution is about 0.5:1 to about 0.8:1; the mixture is statically placed for about 30 minutes to about 40 minutes; then, the mixture is filtered to remove impurities to produce the anti-fingerprint agent.

15. The surface treatment method as claimed in claim 8, wherein the anti-fingerprint coating is formed by the following steps: the substrate is immersed in the anti-fingerprint agent for about 20 s to about 30 s, then the substrate is baked at an oven temperature of about 150° C. to about 200° C.

16. An article, comprising:
a substrate; and
an anti-fingerprint coating formed on the substrate, anti-fingerprint agent being used to form the anti-fingerprint coating substantially comprising liquid polytetrafluroethylene and silane solution, the volume ratio of the liquid polytetrafluroethylene to silane solution being about 0.5:1 to about 0.8:1, the silane solution substantially comprising methyl triethoxyl silane, ethyl silicate, absolute ethanol, deionized water, and sulfuric acid solution.

17. The article as claimed in claim 16, wherein the substrate is a metal substrate, a metal substrate coated with metal compound layer or metal layer, or a non-metal substrate coated with metal compound layer or metal layer.

18. The article as claimed in claim 17, wherein the metal compound is a compound formed from at least one metal element and at least one non-metal element, wherein the metal element is selected from a group consisting of Al, Ti, Cr, Mg, Zr and Ni, the non-metal element is selected from a group consisting of O, C, N and P.

19. The article as claimed in claim 17, wherein the metal layer is made of one or more metal elements selected from a group consisting of Al, Ti, Cr, Mg, Zr and Ni.

20. The article as claimed in claim 16, wherein the anti-fingerprint coating has a thickness of about 5 μm to about 10 μm.
